(19) United States
(12) Patent Application Publication
(10) Pub. No.: US 2026/0158386 A1
(43) Pub. Date: Jun. 11, 2026

(54) TASK PROMPTING IN GAME

(71) Applicant: NETEASE (HANGZHOU) NETWORK CO., LTD., Hangzhou (CN)

(72) Inventor: Ziyan ZHONG, Hangzhou (CN)

(21) Appl. No.: 19/129,252

(22) PCT Filed: Jul. 25, 2023
(86) PCT No.: PCT/CN2023/109104

§ 371 Date: May 12, 2025

(30) Foreign Application Priority Data
Nov. 11, 2022 (CN) 202211414919.6

(51) Int. Cl. A63F 13/5378

(52) U.S. Cl. CPC A63F 13/5378

(57) ABSTRACT

The present disclosure provides a task prompting method in a game, including: displaying a game scene, a scene map, and a task area on a graphical user interface; displaying an object identifier corresponding to a target interaction object at a map location corresponding to a specified location; displaying an object state identifier corresponding to the target interaction object in the task area; controlling, in response to a control instruction for a first virtual character, the first virtual character to execute a target interaction behavior with the target interaction object located at the specified location; determining a state parameter of the target interaction object based on the target interaction behavior; and changing, based on the state parameter, the object state identifier corresponding to the target interaction object, and displaying an updated object state identifier on a second terminal device corresponding to at least one second virtual object.

### CROSS REFERENCE TO RELATED APPLICATIONS

The present disclosure is a 371 national phase application of PCT Application No. PCT/CN 2023/109104 filed Jul. 25, 2023, which claims priority to the Chinese Patent Application No. 202211414919.6, entitled “Method and Apparatus for Giving Prompt for Task in Game, and Electronic Terminal” and filed with the China National Intellectual Property Administration on Nov. 11, 2022, the entire content of which applications are incorporated into the present disclosure by reference.

### TECHNICAL FIELD

The present disclosure relates to the technical field of games, and in particular, to a and apparatus for giving a prompt for a task in a game.

### BACKGROUND

In many games, a virtual character controlled by a player needs to complete various game tasks in a game scene, for example, deciphering a password, obtaining a virtual object, rescuing a virtual character, operating a virtual switch, and other similar game tasks. Currently, a prompt manner for these game tasks is to indicate the quantity of game tasks to be executed or the quantity of game tasks that have been completed. For example, performing data refresh is triggered each time when it is determined that execution of the game task is completed, and refreshed data is synchronized to the front end to update display of interface information about the quantity of game tasks that have been completed.

However, for the current prompt manner, it often occurs that when the player controls the virtual character to move to a task execution location, the task has already been completed or is being executed by a teammate. As a result, the player has to change the task execution location again for the virtual character, which negatively affects the game experience of the player. Therefore, the existing prompt solutions fail to give an effective game task prompt to the player, resulting in low prompt efficiency for a game task at present.

### SUMMARY

The present disclosure provides a method, system, and apparatus for providing a prompt for a task in a game, which may alleviate the technical problem of low task prompt efficiency.

According to a first aspect, the present disclosure introduces a method for providing a prompt for a task in a game, the method comprising: displaying, on a graphical user interface of a first terminal device, s game scene, a scene map corresponding to the game scene, and a task area, where the game scene comprises a first virtual character controlled by the first terminal device and at least one second virtual object controlled by a second terminal device, and a target interaction object is set at each of at least two specified locations in the game scene; displaying, in the scene map, an object location identifier corresponding the target interaction object at a map location; displaying, in the task area, an object state identifier corresponding to the target interaction object, where the object location identifier is in one-to-one correspondence with a respective object state identifier; controlling, in response to a control instruction for the first virtual character, the first virtual character to execute a target interaction behavior with the target interaction object located at the specified location; determining a state parameter of the target interaction object based on the target interaction behavior; and changing, based on the state parameter, the object state identifier corresponding to the target interaction object, and displaying an updated object state identifier on the second terminal device corresponding to the at least one second virtual object.

According to a second aspect, the present disclosure provides a system including one or more memory collectively containing one or more programs, and one or more processors, where the one or more processors are configured to, individually or collectively, perform the operations of one or more steps of the above method for providing a prompt for a task in a game.

According to a third aspect, the present disclosure provides one or more non-transitory computer-readable storage media containing, in any combination, computer program code that, when executed by a computer system, perform operations of one or more steps of the above method for providing a prompt for a task in a game.

In order to make the above objectives, features, and advantages of the present disclosure clearer and understandable, preferred embodiments are provided below in detail with reference to the drawings.

### BRIEF DESCRIPTION OF THE DRAWINGS

In order to more clearly illustrate technical solutions in the detailed description of the present disclosure or in the related art, the drawings used in the detailed description or the related art will be briefly described below. Clearly, the drawings in the description below only represent some implementations of the present disclosure, and for persons of ordinary skill in the art, other drawings can also be obtained from these drawings without the exercise of inventive effort.

FIG. 1 shows a schematic diagram of an application scenario according to one of the embodiments of the present disclosure;

FIG. 2 shows a schematic structural diagram of a mobile phone according to one of the embodiments of the present disclosure;

FIG. 3 shows a schematic diagram of a usage scenario of a touch terminal according to one of the embodiments of the present disclosure;

FIG. 4 shows a schematic flowchart of a method for giving a prompt for a task in a game according to one of the embodiments of the present disclosure;

FIG. 5 shows a schematic diagram of a terminal device for displaying a graphical user interface according to one of the embodiments of the present disclosure;

FIG. 6 shows a schematic diagram of another terminal device for displaying a graphical user interface according to one of the embodiments of the present disclosure;

FIG. 7 shows a schematic diagram of another terminal device for displaying a graphical user interface according to one of the embodiments of the present disclosure;

FIG. 8 shows a schematic diagram of another terminal device for displaying a graphical user interface according to one of the embodiments of the present disclosure;

FIG. 9 shows a schematic structural diagram of an apparatus for promoting a task in a game according to one of the embodiments of the present disclosure; and

FIG. 10 shows a schematic structural diagram of an electronic device according to one of the embodiments of the present disclosure.

### DETAILED DESCRIPTION

In order to make the objectives, technical solutions, and advantages of embodiments of the present disclosure clearer, the technical solutions in the present disclosure will be clearly and completely described below with reference to the drawings, and it is obvious that the described embodiments are only some, rather than all, of the embodiments of the present disclosure. All other embodiments obtained by persons of ordinary skill in the art based on the embodiments of the present disclosure without the exercise of inventive effort shall fall within the scope of protection of the present disclosure.

The terms “include” and “have” and any variations thereof mentioned in the embodiments of the present disclosure are intended to cover non-exclusive inclusion. For example, a process, method, system, product, or device that includes a series of steps or units is not limited to the listed steps or units, but may further includes other steps or units that are not listed, or may further includes other steps or units inherent to the process, method, product, or device.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, to perform a particular function.

At present, in many asymmetric competitive games, only the target deciphering quantity and the quantity of deciphered targets are indicated to give a prompt for the state of a deciphering target for a survivor. A display mechanism in the existing game is triggered by completion of the deciphering to perform data refresh and refreshed data is synchronized to the front end to update display of the quantity of deciphered targets. Specifically, performing data refresh is triggered each time it is determined that the deciphering is completed and the refreshed data is synchronized to the front end to update display of interface information about the quantity of deciphered targets. However, in the current display mechanism, there are many disadvantages in the solution thereof.

For example, during the game, information about the deciphering target is only displayed by text at the top of a graphical user interface. For example, a display form is “X passwords have not been deciphered”, where X is initially the target quantity of passwords to be deciphered, and the data is refreshed each time deciphering of one deciphering point is completed, and namely, becomes X-1. In the existing solution, for the survivor who needs to complete deciphering of all target points as soon as possible so as to enter the evacuation stage, since information about the deciphering point is not displayed on the user interface, it often occurs in the early stage that deciphering of the deciphering point which the survivor runs to has been completed or is being performed by a teammate, and the survivor needs to change the deciphering point again. Furthermore, in this text display manner, the dynamically changing information is only displayed by numbers, and there is no feedback of the state change, and consequently it is difficult for the player to know the specific deciphering situation.

For another example, information about the deciphering target is displayed by symbols at the top of the graphical user interface. For example, the display form is that five dots represent the quantity of deciphering targets, all of which are initially gray, and each time deciphering of one deciphering point is completed, one gray dot is replaced with a white dot from left to right for display and refresh. For this solution, the dot symbol is not displayed for the state of the deciphering point, and it often occurs in the early stage that deciphering of the deciphering point which the survivor runs to has been completed or is being performed by a teammate, and the survivor needs to change the deciphering point again. In addition, the deciphering point is not displayed in association with the dot symbol in the user interface. Therefore, it is difficult for a user to understand the meaning represented by the five dots, which affects the game experience of the player.

Therefore, the existing prompt solutions fail to give an effective game task prompt to the player, resulting in low prompt efficiency for a game task at present.

Based on this, embodiments of the present disclosure provide a method and apparatus for giving a prompt for a task in a game, and an electronic terminal, so that the technical problem of low prompt efficiency for a game task at present can be alleviated through the method.

The method for giving a prompt for a task in a game in one of the embodiments of the present disclosure may run in a local terminal device or a server. When the method for giving a prompt for a task in a game runs in the server, the method may be implemented and executed on the basis of a cloud interaction system, where the cloud interaction system includes a server and a client device.

In one embodiment, various cloud applications may be run under the cloud interaction system, for example: cloud gaming. Using the cloud gaming as an example, the cloud gaming refers to a gaming means based on cloud computing. In a running mode of the cloud gaming, a running main body of a game program and a game screen presentation main body are separate, storing and running of the method for giving a prompt for a task in a game are completed on a cloud gaming server, and a client device functions to receive and send data and present game screens. For example, the client device may be a display device having a data transmission function close to a user side, such as a mobile terminal, a television, a computer, and a handheld computer. However, information processing is performed by the cloud game server in the cloud. When a game is played, a player operates the client device to send an operation instruction to the cloud game server, the cloud game server runs the game according to the operation instruction, encodes and compresses data such as a game screen, returns the data to the client device via a network, and finally decodes and outputs the game screen by means of the client device.

In another embodiment, using a game as an example, a local terminal device stores a game program and is used to present game screens. The local terminal device is used to interact with a player via a graphical user interface, i.e., conventionally download and install the game program via an electronic device and run the game program. The local terminal device may provide the graphical user interface to the player in a variety of ways, for example, the graphical user interface may be rendered on a display screen of a terminal, or may be provided to the player by means of holographic projection. For example, the local terminal device may include a display screen and a processor, the display screen being used for presenting the graphical user interface including a game screen, and the processor being used for running the game, generating the graphical user interface, and controlling the display of the graphical user interface on the display screen.

The embodiments of the present disclosure achieve the following beneficial effects.

The embodiments of the present disclosure provide a method and apparatus for providing a prompt for a task in a game. A graphical user interface of a terminal device displays a game scene, a scene map corresponding to the game scene, and a task area. The game scene includes a first virtual character controlled by the first terminal device and at least one second virtual object controlled by a second terminal device. The target interaction object is set at each of the at least two specified locations in the game scene. The object location identifier corresponding to the target interaction object is displayed at the map location corresponding to the specified location in the scene map. The object state identifier corresponding to the target interaction object is displayed in the task area, and the object location identifier is in one-to-one correspondence with a respective object state identifier. In response to the control instruction for the first virtual character, the first virtual character is controlled to execute the target interaction behavior with the target interaction object located at the specified location. The state parameter of the target interaction object is determined based on the target interaction behavior. The object state identifier corresponding to the target interaction object is changed based on the state parameter, and the updated object state identifier is displayed on the second terminal device corresponding to the at least one second virtual object.

In the disclosed embodiments, a prompt for the specified location of the target interaction object is provided to the player, and the state parameter of the target interaction object is determined according to the target interaction behavior executed by the virtual character with the target interaction object. The object state identifier corresponding to the target interaction object on each terminal device is then changed according to the state parameter, which enables more effective prompting of target interaction objects whose associated interaction behavior has not yet been executed. Through the disclosed approach, the player can know the specified location of each target interaction object that really needs to execute the target interaction behavior. This avoids the situations where the virtual character arrives at the specified location only to find that the target interaction behavior which needs to be executed by the virtual character with the target interaction object has been completed or the target interaction behavior is being executed, and consequently requiring the player to change a task execution location again. The disclosed approach improves the game experience of the player, prompts efficiency for game tasks such as the interaction behavior. Therefore, the approach alleviates the technical problem of low prompt efficiency for a game task, reduces the processing burden of the terminal device, and saves the power of the terminal device.

In a possible implementation, an embodiment of the present disclosure provides a method for giving a prompt for a task in a game. A graphical user interface is provided by a terminal device, where the terminal device may be the local terminal device mentioned above, or may be the client device in the cloud interaction system mentioned above.

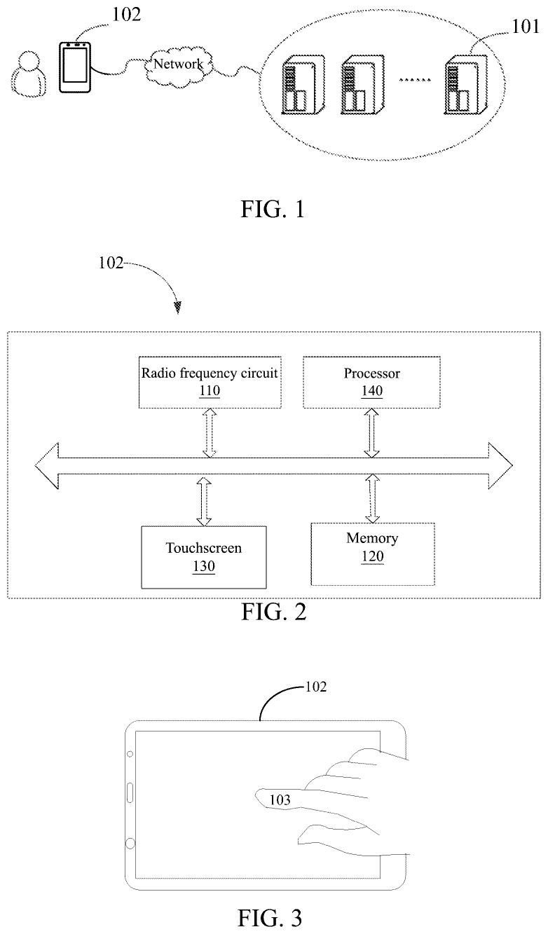

For example, as shown in FIG. 1, FIG. 1 is a schematic diagram of an application scenario according to an embodiment of the present disclosure. The application scenario may include a touch terminal (for example, a mobile phone 102) and a server 101, and the touch terminal may communicate with the server 101 through a wired network or a wireless network. The touch terminal is configured to run a virtual desktop, and may interact with the server 101 through the virtual desktop, to control content in the server 101.

The touch terminal in this embodiment is described by taking the mobile phone 102 as an example. The mobile phone 102 includes components such as a radio frequency (RF for short) circuit 110, a memory 120, a touchscreen 130, and a processor 140. Persons skilled in the art can understand that a mobile phone structure shown in FIG. 2 does not constitute a limitation on a mobile phone, and the mobile phone may include more or fewer components than those shown in the figure, or combine some components, or split some components, or have different component arrangements. Persons skilled in the art may understand that the touchscreen 130 is a user interface (UI for short), and the mobile phone 102 may include more or fewer user interfaces than those shown in the figure.

The RF circuit 110 may also communicate with a network and another device through wireless communication. The wireless communication may use any communication standard or protocol, including, but not limited to, a global system of mobile communication (GSM for short), a general packet radio service (GPRS for short), code division multiple access (CDMA for short), wideband code division multiple access (WCDMA for short), long term evolution (LTE for short), an email, a short messaging service (SMS for short), and the like.

The memory 120 may be configured to store a software process and a module, and the processor 140 runs the software process and the module that are stored in the memory 120, to perform various function applications and data processing of the mobile phone 102. The memory 120 may mainly include a program storage area and a data storage area, where the program storage area may store an operating system, an application program required by at least one function, and the like. The data storage area may store data created according to use of the mobile phone 102, and the like. In addition, the memory 120 may include a high-speed random access memory, and may further include a non-volatile memory, for example, at least one magnetic disk storage device, a flash memory device, or another volatile solid-state storage device.

The processor 140 is a control center of the mobile phone 102, connects various parts of the entire mobile phone by using various interfaces and lines, and performs various functions of the mobile phone 102 and processes data by running or executing the software program and/or the module stored in the memory 120 and calling the data stored in the memory 120, so as to perform overall monitoring of the mobile phone.

The embodiment of the present disclosure will be further described below with reference to the drawings.

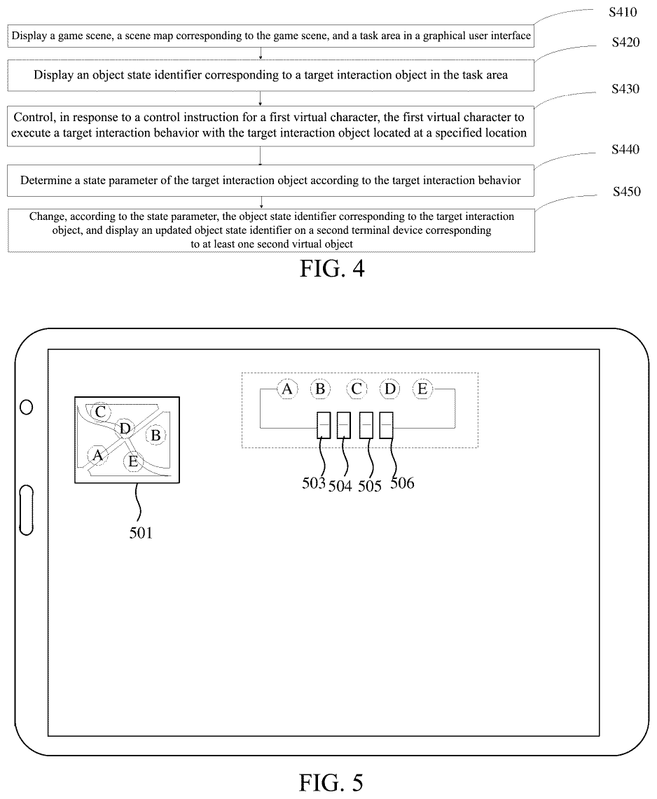

FIG. 4 is a schematic flowchart of a method for giving a prompt for a task in a game according to an embodiment of the present disclosure. The method may be applied to a terminal device (for example, the mobile phone 102 shown in FIG. 2) that can present a graphical user interface, the graphical user interface is provided by a first terminal device, and a game scene of the game at least includes a first virtual character controlled by the first terminal device and at least one second virtual object controlled by a second terminal device. As shown in FIG. 4, the method includes Step S410: Displaying the game scene, a scene map corresponding to the game scene, and a task area in the graphical user interface.

A target interaction object is set at each of at least two specified locations in the game scene. An object location identifier of a corresponding target interaction object is displayed at a map location corresponding to the specified location in the scene map.

In practical applications, there may be a plurality of game tasks that the virtual character needs to execute, for example, a target interaction behavior that needs to be executed by the virtual character with the target interaction object and other game tasks. An execution location of each game task can be directly displayed in the graphical user interface in a one-to-one manner for each game task. For example, the game task is to decipher a password, and in this step, a point for deciphering the password, which is a deciphering location of the password, can be directly displayed in the graphical user interface in a one-to-one manner.

In one embodiment, the location identifier may be a relatively large area range on the graphical user interface, or may be a relatively small area range on the graphical user interface. The location identifier may be in the shape of a square, a rectangle, or a block, or in other shapes (for example, a shape of a circle). Content presented by the graphical user interface may include the whole location identifier, or may be a part of a content hotspot. For example, when the location identifier is enlarged and displayed on the graphical user interface, local content of the content hotspot is displayed on the graphical user interface of the terminal device. The location identifier may be displayed on the upper left, the upper right, or other locations on the graphical user interface, which is not limited in this exemplary embodiment.

It should be noted that there may be a plurality of indication forms of the location identifier. For example, the location identifier in the form of text directly specifies, by the text, the specified location for executing the game task. For another example, the location identifier in the form of an image indicates, by a graphic image or the like, the specified location for executing the game task. In some embodiments, the specified location for executing the game task may be indicated in an indication form such as a combination of text and an image.

In some embodiments, a prompt for the specified location for executing each game task may be given in the scene map, so that the player can quickly find the specified location for executing each game task by using a mini-map. In practical applications, the object location identifier may be an identifier in any form such as a letter, a number, or a pattern. Exemplarily, as shown in FIG. 5, all the deciphering points “A”, “B”, “C”, “D”, and “E” are displayed in a mini-map 501 corresponding to the game scene, and specified locations for executing game tasks correspond to different locations in the mini-map.

For example, code names (object location identifiers corresponding to the game task) of all the deciphering points are displayed in the mini-map on the left side of the interface, so that the player can quickly find the deciphering point by using the mini-map without being familiar with the level layout, thereby reducing the learning cost of a game novice.

Step S420: Displaying an object state identifier corresponding to the target interaction object in the task area.

Object location identifiers are in one-to-one correspondence with object state identifiers. A change manner of the object state identifier includes any one or a plurality of the following: changing color, changing brightness, changing transparency, changing a shape, and/or changing an effect dynamically.

The object state identifier may also be displayed in the task area so as to correspond to a game task prompt in the map, so that the player can view game task-related information more clearly. Object location identifiers displayed in the scene map are in one-to-one correspondence with object state identifiers displayed in the task area, and the task area is located in an area outside the scene map. For example, as shown in FIG. 5, all the deciphering points “A”, “B”, “C”, “D”, and “E”, namely, the game tasks, are displayed in both a task area 502 at the top of the graphical user interface and the mini-map 501, the deciphering points display unique code names (object state identifiers corresponding to the game task) of the points in a one-to-one manner, and the code name (object state identifier) of the point displayed in the task area may correspond to the code name (object location identifier) of the point displayed in the left-side mini-map, so that the object state identifier in the task area corresponds to an object location identifier prompt in the scene map, and the player can view the game task-related information more clearly.

Step S430: Controlling, in response to a control instruction for the first virtual character, the first virtual character to execute the target interaction behavior with the target interaction object located at the specified location.

The interaction behavior in the embodiment of the present disclosure may be various types of behaviors with continuous processes, for example, deciphering a password, obtaining a virtual object, rescuing a virtual character, operating a virtual switch, and other game tasks. The embodiment of the present disclosure is described by using an example that the game task is a deciphering behavior.

Step S440: Determining a state parameter of the target interaction object according to the target interaction behavior.

The state parameter includes any one or a plurality of the following: execution of the behavior not starting, the execution of the behavior being in progress, the execution of the behavior being completed, an execution progress of the behavior, an execution stage of the behavior, the execution of the behavior being interrupted, and/or the execution of the behavior stopping.

Step S450: Changing, according to the state parameter, the object state identifier corresponding to the target interaction object, and displaying an updated object state identifier on the second terminal device corresponding to the at least one second virtual object.

In one embodiment, when an object state of a certain target interaction object in a plurality of interaction objects changes, behavior execution progress data of the target interaction object is read from a server in real time, and a client refreshes a display form of the object state identifier corresponding to the target interaction object in the graphical user interface according to the progress data.

Exemplarily, when a certain password to be deciphered in a plurality of passwords to be deciphered has been deciphered, display of an identifier of a deciphering location where the password is deciphered is canceled in the graphical user interface. Specifically, a location identifier corresponding to the password that has been deciphered is no longer displayed, so that the player does not need to pay attention to the password that has been deciphered, namely, the game task that has been completed.

In the embodiment of the present disclosure, a prompt for the specified location of the target interaction object is given to the player, and the state parameter of the target interaction object is determined according to the target interaction behavior which is executed by the virtual character with the target interaction object. Then the object state identifier corresponding to the target interaction object on each terminal device is changed according to the state parameter, and the prompt for the specified location of the target interaction object that has not yet executed the target interaction behavior can be more effectively given, so that the player can know the specified location of each target interaction object that really needs to execute the target interaction behavior, thereby avoiding the situation that when the virtual character arrives at the specified location, the target interaction behavior which needs to be executed by the virtual character with the target interaction object has been completed or the target interaction behavior is being executed, and consequently the player needs to change a task execution location again. This improves the game experience of the player and prompt efficiency for game tasks such as the interaction behavior, thereby alleviating the technical problem of low prompt efficiency for a game task at present, and also reducing the processing burden of the terminal device and saving the power of the terminal device.

The above steps will be described in detail below.

In some embodiments, change situations of various execution states of the game task may also be synchronously displayed by using the location identifier corresponding to the game task, for example, a deciphering progress of the deciphering point is synchronized in real time. An execution state of each game task can be clarified by displaying the location identifier corresponding to the game task, so that it is convenient for the player to make a more strategic selection in advance for each game task and then go to the corresponding specified location, preventing the situation of a futile attempt caused by the unclear state of the deciphering point, and increasing the effectiveness of the player in controlling the behavior of the virtual character.

The execution state of the game task may include any one or a plurality of the following: execution not starting, the execution being in progress, the execution being completed, an execution progress, and/or an execution stage. For example, a deciphering state of a password may include deciphering not starting, the deciphering being in progress, a deciphering progress situation, the deciphering being completed, and the like.

As an example, the above step S450 may include the following step: Step c): Changing, according to the behavior execution progress of the target interaction object, the object state identifier corresponding to the target interaction object, and displaying an updated behavior execution progress at the object state identifier on the second terminal device corresponding to the at least one second virtual object.

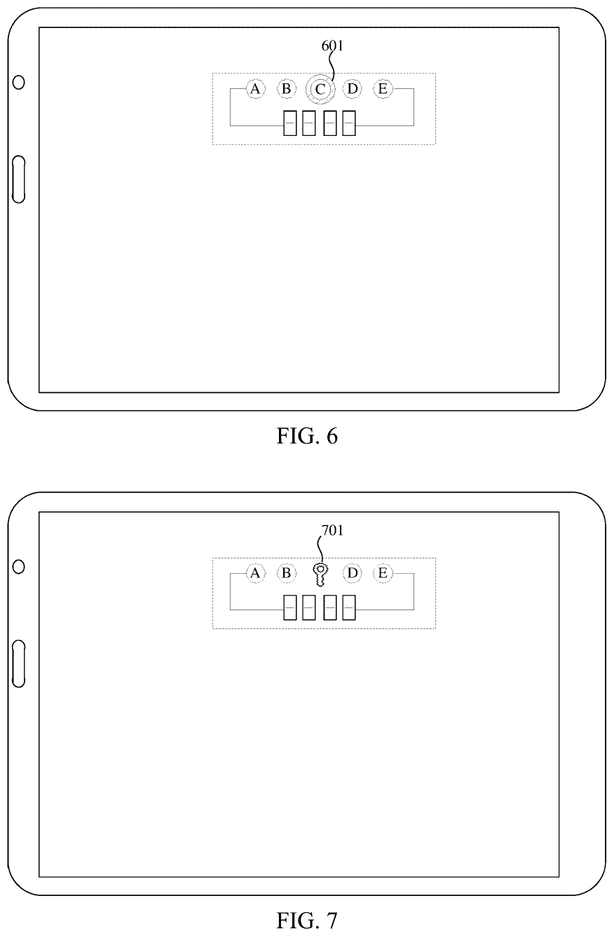

For example, as shown in FIG. 6, a deciphering progress (execution progress) of the third deciphering point, namely, the deciphering point [C], is indicated by an annular progress 601 bar. No progress bar is displayed on the deciphering points [A], [B], [D], and [E], which represents that the deciphering progress of these deciphering points is 0.

In practical applications, a change of the execution state of the game task may be represented in a special display form. Exemplarily, progress bars in different states are used to indicate different progress situations, for example, execution of the task stopping, the execution of the task being interrupted, the execution of the task regressing, and a password submitting stage during execution of the task.

For example, when it is detected that the deciphering point is being deciphered, a display state of the progress bar is updated to be green while there is a rotation state with a directional arrow. For another example, when it is detected that the deciphering of the deciphering point stops, the progress bar is displayed in a static state. For another example, when the deciphering is suddenly interrupted, the progress is shown as a red color during the regression due to a special regression mechanism of the game. A dark red part of the red color represents the progress that would be deducted over time if the deciphering does not continue. Exemplarily, in a case that the deciphering is interrupted, a decipherer moves out of a deciphering range and the progress bar stops progressing. When the deciphering stops, the progress bar does not move. For example, 33% and 66% are checkpoints. If the deciphering progress is interrupted when less than 33%, the progress bar will drop back to 0% within a certain time. If the deciphering progress is interrupted when greater than 33% and less than 66%, the progress bar will drop back to 33% within a certain time. If the deciphering progress is interrupted when greater than 66% and less than 100%, the progress bar will drop back to 66% within a certain time.

For another example, as shown in FIG. 7, when the deciphering progress reaches 100%, a special game-playing mechanism of submitting passwords at a specific location may be set, and during submission of the passwords after deciphering is completed, point information is replaced with a display key 701. Each time one password key is submitted, it represents that the deciphering target is completed one time.

By changing a display color and/or a display shape of a location identifier corresponding to a certain game task, the change situation of the execution progress of the certain game task is indicated, so as to enhance state feedback of the execution of the task, such as state feedback of the point being deciphered, by using a special color or shape and a dynamic effect.

As another example, the above step S450 may include the following step.

Step d): Canceling, if the state parameter indicates that the execution of the target interaction behavior corresponding to the target interaction object is completed, display of the object state identifier corresponding to the target interaction object, and canceling, on the second terminal device corresponding to the at least one second virtual object, the display of the object state identifier.

Exemplarily, after the point information is replaced with the key, and after one password key is submitted, namely, after the deciphering target is completed one time, all related identifiers, such as the location identifier and the object state identifier, of the game task may no longer be displayed in the graphical user interface.

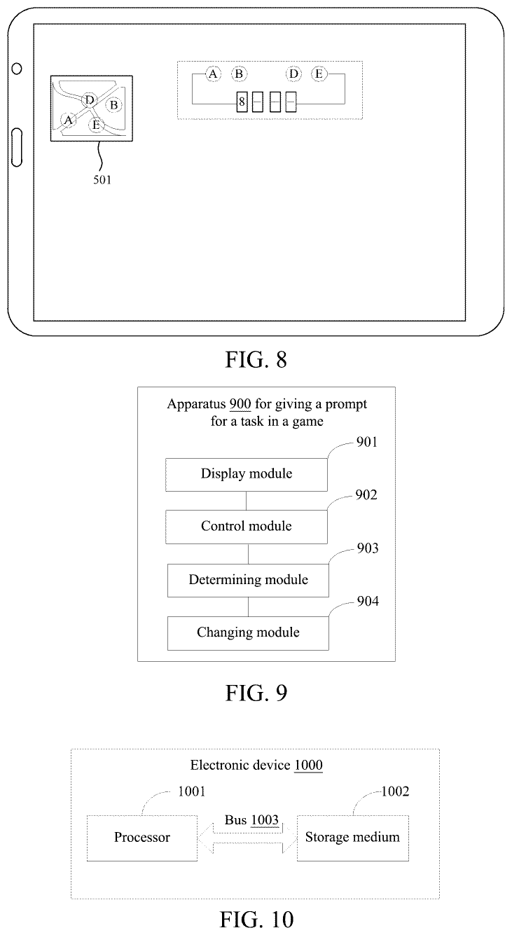

For example, as shown in FIG. 8, the point [C] in the task area becomes an empty slot, and a point code name C in the left-side mini-map 501 disappears synchronously, which represents that the deciphering target at the point has been completed, so that the player can find that no attention needs to be paid to the game task.

In some embodiments, the game task may also be executed by several second virtual characters other than the first virtual character controlled by the player, and a system may further monitor, in real time, an execution situation of the game task by these second virtual characters, so as to effectively, quickly and timely monitor a change situation of the execution state of the game task. In practical applications, the first virtual character controlled by the player may have at least one teammate, and the second virtual characters controlled by these teammates may also execute the game task corresponding to the first virtual character, namely, the game task in the embodiment of the present disclosure may be completed as a team task by a plurality of virtual characters in a team.

In the embodiment of the present disclosure, the system may monitor, in real time, the execution situation of the game task by these second virtual characters, for example, the monitoring starts when the second virtual character starts to execute the game task, and the monitoring starts when the second virtual character reaches the specified location, so as to effectively, quickly and timely monitor the change situation of the execution state of the game task.

In some embodiments, the graphical user interface may further display task content corresponding to each game task, for example, the location identifier and the task content are displayed in combination, so that the player directly views the task content to be executed. As an example, the method may further include the following step.

Step f): Displaying content of the target interaction behavior corresponding to each target interaction object in the task area.

The content of the target interaction behavior is associated with the object state identifier. The location identifier may be greater than or equal to the task content, namely, the content of the target interaction behavior. For example, as shown in FIG. 5, in a display form in which the deciphering point and the deciphering target are combined, four password digits, namely, a password digit 503, a password digit 504, a password digit 505, and a password digit 506, represent the quantity of deciphering targets, and all initial states of passwords that have not been deciphered are a default state “-”, which indicates that all game task requirements can be satisfied only when deciphering of the four passwords is completed. For the five deciphering points (location identifiers) [A], [B], [C], [D], and [E], the player can select any four of the deciphering points, and as long as deciphering of any four of the deciphering points is completed, all the four password digits are completed. Therefore, all the game task requirements are satisfied, thereby reducing the difficulty of completing the game task through free selection of the player.

In the embodiment of the present disclosure, the content of the target interaction behavior includes any one or a plurality of the following: deciphering a password, obtaining a virtual object, rescuing a virtual character, and/or operating a virtual switch.

In practical applications, a display mode of the content of the target interaction behavior is a style of the target interaction object. For example, as shown in FIG. 5, the deciphering target is graphically displayed as a style of a password board at the top of the user interface, to assist a user in understanding a deciphering behavior and fit a psychological model of the user.

The task content corresponding to each game task is displayed through the graphical user interface, which can display the location identifier and the task content in combination, so that the player can directly view the task content of each game task to be executed and the location identifier corresponding thereto, and the task content can correspond to the location identifier corresponding thereto, which is convenient for the player to view and determine the game task to be executed.

Based on the above step f), when the execution of the game task is completed, the game content correspondingly displayed by the game task may be synchronously refreshed, so that a corresponding task execution result is displayed by the game task, thereby making prompt of a completion effect of the game task more visual. As an example, the method may further include the following step.

Step g): Updating, in response to that the execution of the target interaction behavior corresponding to the target interaction object is completed, the content of the target interaction behavior corresponding to the target interaction object in the task area to an interaction behavior execution result corresponding to the target interaction object.

In practical applications, a task execution result corresponding to the content of the game task, namely, the target interaction behavior, may be in various forms such as a number, text, and a pattern. For example, in the deciphered content represented by the password board used when deciphering of the password is executed, as shown in FIG. 8, a display mechanism is that four password digits represent the quantity of deciphering targets, with all the password digits being in the default initial states “-” in which the passwords are not deciphered, each time one deciphering target is completed, a number “8” is added from left to right, with the initial state “-” being replaced with a number representing the deciphered password from left to right for display and refresh.

Each time the execution of the task is completed, the task content is refreshed and displayed as the task execution result, namely, refreshed and displayed as the task execution result corresponding to the game task, so that prompt feedback of the completion effect of the game task is more visual and convenient for the player to view.

Based on the above step g), when the execution of the game task is completed, a feedback prompt indicating that the execution of the game task is completed may also be displayed through a dynamic effect, to enhance visual feedback indicating that the execution of the game task is completed, so that the feedback prompt indicating that the game task is completed is more obvious and convenient for the player to view. As an example, before the content of the target interaction behavior corresponding to the target interaction object in the task area is updated to the interaction behavior execution result corresponding to the target interaction object in the above step g), the method may further include the following step.

Step h): In response to that the execution of the target interaction behavior corresponding to the target interaction object is completed, displaying an association effect between the content of the target interaction behavior and the object state identifier according to a preset dynamic display effect.

Exemplarily, in the form of displaying the deciphering point (location identifier) and the deciphering target (content of the target interaction behavior) in combination, each time the deciphering target is completed, playing of a visual special effect for dynamic linking from the deciphering point to the deciphering target is completed one time, and then a task completion result displayed by the deciphering target is refreshed, thereby increasing association between the deciphering point and the deciphering target, and meanwhile, enhancing the visual feedback of a state change of the deciphering target.

FIG. 9 provides a schematic structural diagram of an apparatus for giving a prompt for a task in a game. The apparatus may be applied to a terminal device. A graphical user interface is provided by a first terminal device, and a game scene of the game at least includes a first virtual character controlled by the first terminal device and at least one second virtual object controlled by a second terminal device. As shown in FIG. 9, the apparatus 900 for giving a prompt for a task in a game includes: a display module 901, configured to display the game scene, a scene map corresponding to the game scene, and a task area in the graphical user interface, where a target interaction object is set at each of at least two specified locations in the game scene; and display an object location identifier of a corresponding target interaction object at a map location corresponding to the specified location in the scene map; the display module being further configured to display an object state identifier corresponding to the target interaction object in the task area, object location identifiers being in one-to-one correspondence with object state identifiers; a control module 902, configured to control, in response to a control instruction for the first virtual character, the first virtual character to execute a target interaction behavior with the target interaction object located at the specified location; a determining module 903, configured to determine a state parameter of the target interaction object according to the target interaction behavior; and a changing module 904, configured to change, according to the state parameter, the object state identifier corresponding to the target interaction object, and display an updated object state identifier on the second terminal device corresponding to the at least one second virtual object.

By means of the above manner, a prompt for the specified location of the target interaction object is given to the player, and the state parameter of the target interaction object is determined according to the target interaction behavior which is executed by the virtual character with the target interaction object. Then the object state identifier corresponding to the target interaction object on each terminal device is changed according to the state parameter, and the prompt for the specified location of the target interaction object that has not yet executed the target interaction behavior can be more effectively given, so that the player can know the specified location of each target interaction object that really needs to execute the target interaction behavior, thereby avoiding the situation that when the virtual character arrives at the specified location, the target interaction behavior which needs to be executed by the virtual character with the target interaction object has been completed or the target interaction behavior is being executed, and consequently the player needs to change a task execution location again. This improves the game experience of the player and prompt efficiency for game tasks such as the interaction behavior, thereby alleviating the technical problem of low prompt efficiency for a game task at present, and also reducing the processing burden of the terminal device and saving the power of the terminal device.

In a feasible implementation solution, the state parameter includes any one or a plurality of the following: execution of the behavior not starting, the execution of the behavior being in progress, the execution of the behavior being completed, an execution progress of the behavior, an execution stage of the behavior, the execution of the behavior being interrupted, and/or the execution of the behavior stopping.

In a feasible implementation solution, a change manner of the object state identifier includes any one or a plurality of the following: changing color, changing brightness, changing transparency, changing a shape, and/or changing an effect dynamically.

In a feasible implementation solution, the changing module is specifically configured to change, according to a behavior execution progress of the target interaction object, the object state identifier corresponding to the target interaction object, and display an updated behavior execution progress at the object state identifier on the second terminal device corresponding to the at least one second virtual object.

In a feasible implementation solution, the changing module is specifically configured to cancel, if the state parameter indicates that the execution of the target interaction behavior corresponding to the target interaction object is completed, display of the object state identifier corresponding to the target interaction object, and cancel, on the second terminal device corresponding to the at least one second virtual object, the display of the object state identifier.

In a feasible implementation solution, the display module is further configured to display content of a target interaction behavior corresponding to each target interaction object in the task area; where the content of the target interaction behavior is associated with the object state identifier.

In a feasible implementation solution, the content of the target interaction behavior includes any one or a plurality of the following: deciphering a password, obtaining a virtual object, rescuing a virtual character, and/or operating a virtual switch.

In a feasible implementation solution, a display mode of the content of the target interaction behavior is a style of the target interaction object.

In a feasible implementation solution, the apparatus further includes an updating module, configured to update, in response to that the execution of the target interaction behavior corresponding to the target interaction object is completed, the content of the target interaction behavior corresponding to the target interaction object in the task area to an interaction behavior execution result corresponding to the target interaction object.

In a feasible implementation solution, the display module is further configured to, in response to that the execution of the target interaction behavior corresponding to the target interaction object is completed, display an association effect between the content of the target interaction behavior and the object state identifier according to a preset dynamic display effect.

The apparatus for giving a prompt for a task in a game provided by the embodiment of the present disclosure has the same technical features as the method for giving a prompt for a task in a game provided by the above embodiment, and therefore can also solve the same technical problem and achieve the same technical effect.

FIG. 10 shows a schematic structural diagram of an electronic device according to an embodiment of the present disclosure. The electronic device includes: a processor 1001, a storage medium 1002, and a bus 1003. The storage medium 1002 stores machine-readable instructions executable by the processor 1001. When the electronic device runs a method 101010 as in the embodiments, the processor 1001 communicates with the storage medium 1002 by means of the bus 1003, the processor 1001 executes the machine-readable instructions, and the processor 1001 performs the preamble part of the method, to perform the following steps: displaying a game scene, a scene map corresponding to the game scene, and a task area in a graphical user interface, where a target interaction object is set at each of at least two specified locations in the game scene; displaying an object location identifier of a corresponding target interaction object at a map location corresponding to the specified location in the scene map;
displaying an object state identifier corresponding to the target interaction object in the task area, object location identifiers being in one-to-one correspondence with object state identifiers;
controlling, in response to a control instruction for a first virtual character, the first virtual character to execute a target interaction behavior with the target interaction object located at the specified location; determining a state parameter of the target interaction object according to the target interaction behavior; and changing, according to the state parameter, the object state identifier corresponding to the target interaction object, and displaying an updated object state identifier on a second terminal device corresponding to at least one second virtual object.

In a feasible implementation solution, the state parameter includes any one or a plurality of the following: execution of the behavior not starting, the execution of the behavior being in progress, the execution of the behavior being completed, an execution progress of the behavior, an execution stage of the behavior, the execution of the behavior being interrupted, and/or the execution of the behavior stopping.

In a feasible implementation solution, a change manner of the object state identifier includes any one or a plurality of the following: changing color, changing brightness, changing transparency, changing a shape, and/or changing an effect dynamically.

In a feasible implementation solution, when executing the step of changing, according to the state parameter, the object state identifier corresponding to the target interaction object, and displaying an updated object state identifier on the second terminal device corresponding to the at least one second virtual object, the processor is specifically configured to change, according to a behavior execution progress of the target interaction object, the object state identifier corresponding to the target interaction object, and display an updated behavior execution progress at the object state identifier on the second terminal device corresponding to the at least one second virtual object.

In a feasible implementation solution, when executing the step of changing, according to the state parameter, the object state identifier corresponding to the target interaction object, and displaying an updated object state identifier on the second terminal device corresponding to the at least one second virtual object, the processor is specifically configured to cancel, if the state parameter indicates that the execution of the target interaction behavior corresponding to the target interaction object is completed, display of the object state identifier corresponding to the target interaction object, and cancel, on the second terminal device corresponding to the at least one second virtual object, the display of the object state identifier.

In a feasible implementation solution, the processor is further configured to display content of a target interaction behavior corresponding to each target interaction object in the task area; where the content of the target interaction behavior is associated with the object state identifier.

In a feasible implementation solution, the content of the target interaction behavior includes any one or a plurality of the following: deciphering a password, obtaining a virtual object, rescuing a virtual character, and/or operating a virtual switch.

In a feasible implementation solution, a display mode of the content of the target interaction behavior is a style of the target interaction object.

In a feasible implementation solution, the processor is further configured to update, in response to the execution of the target interaction behavior corresponding to the target interaction object being completed, the content of the target interaction behavior corresponding to the target interaction object in the task area to an interaction behavior execution result corresponding to the target interaction object.

In a feasible implementation solution, before the updating the content of the target interaction behavior corresponding to the target interaction object in the task area to an interaction behavior execution result corresponding to the target interaction object, the processor is further configured to, in response to that the execution of the target interaction behavior corresponding to the target interaction object is completed, display an association effect between the content of the target interaction behavior and the object state identifier according to a preset dynamic display effect.

By means of the above manner, a prompt for the specified location of the target interaction object is given to the player, and the state parameter of the target interaction object is determined according to the target interaction behavior which is executed by the virtual character with the target interaction object. Then the object state identifier corresponding to the target interaction object on each terminal device is changed according to the state parameter, and the prompt for the specified location of the target interaction object that has not yet executed the target interaction behavior can be more effectively given, so that the player can know the specified location of each target interaction object that really needs to execute the target interaction behavior, thereby avoiding the situation that when the virtual character arrives at the specified location, the target interaction behavior which needs to be executed by the virtual character with the target interaction object has been completed or the target interaction behavior is being executed, and consequently the player needs to change a task execution location again. This improves the game experience of the player and prompt efficiency for game tasks such as the interaction behavior, thereby alleviating the technical problem of low prompt efficiency for a game task at present, and also reducing the processing burden of the terminal device and saving the power of the terminal device.

In practical applications, the memory 1001 may include a high-speed random access memory (RAM for short), and may further include a non-volatile memory, for example, at least one magnetic disk memory. At least one communication interface 1004 (which may be wired or wireless) is used to implement a communication connection between the system network element and at least one other network element, and the Internet, a wide area network, a local area network, a metropolitan area network, or the like may be used.

The bus 1003 may be an ISA bus, a PCI bus, an EISA bus, or the like. The bus may be classified as an address bus, a data bus, a control bus, and the like. For ease of representation, only one double-sided arrow is used to represent the bus in FIG. 10, but this does not mean that there is only one bus or only one type of bus.

The memory 1001 is configured to store a program, the processor 1002 executes the program after receiving an execution instruction, and the method performed by the apparatus defined by the process disclosed in any foregoing embodiment of the present disclosure may be applied to the processor 1002 or implemented by the processor 1002.

The processor 1002 may be an integrated circuit chip and has a signal processing capability. In an implementation process, the steps in the above method may be completed by using an integrated logical circuit of hardware in the processor 1002, or by using instructions in a form of software. The above processor 1002 may be a general-purpose processor, including a central processing unit (CPU for short), a network processor (NP for short), and the like. In some embodiments, the processor may be a digital signal processor (DSP for short), an application specific integrated circuit (ASIC for short), a field-programmable gate array (FPGA for short) or another programmable logic device, a discrete gate or a transistor logic device, or a discrete hardware component. The methods, steps and logical block diagrams disclosed in the embodiments of the present disclosure may be implemented or executed. The general-purpose processor may be a microprocessor, or the processor may be any conventional processor or the like. The steps of the method disclosed in combination with the embodiments of the present disclosure may be directly executed and completed by a hardware decoding processor, or may be executed and completed by a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory 1001, and the processor 1002 reads information in the memory 1001 and completes the steps of the above method in combination with hardware thereof.

An embodiment of the present disclosure further provides a computer-readable storage medium. The computer-readable storage medium stores a computer program, and when the computer program is run by a processor, the processor performs the following steps: displaying a game scene, a scene map corresponding to the game scene, and a task area in a graphical user interface, where a target interaction object is set at each of at least two specified locations in the game scene; displaying an object location identifier of a corresponding target interaction object at a map location corresponding to the specified location in the scene map; displaying an object state identifier corresponding to the target interaction object in the task area, object location identifiers being in one-to-one correspondence with object state identifiers; controlling, in response to a control instruction for a first virtual character, the first virtual character to execute a target interaction behavior with the target interaction object located at the specified location; determining a state parameter of the target interaction object according to the target interaction behavior; and changing, according to the state parameter, the object state identifier corresponding to the target interaction object, and displaying an updated object state identifier on a second terminal device corresponding to at least one second virtual object.

In a feasible implementation solution, the state parameter includes any one or a plurality of the following: execution of the behavior not starting, the execution of the behavior being in progress, the execution of the behavior being completed, an execution progress of the behavior, an execution stage of the behavior, the execution of the behavior being interrupted, and/or the execution of the behavior stopping.

In a feasible implementation solution, a change manner of the object state identifier includes any one or a plurality of the following: changing color, changing brightness, changing transparency, changing a shape, and/or changing an effect dynamically.

In a feasible implementation solution, when executing the step of changing, according to the state parameter, the object state identifier corresponding to the target interaction object, and displaying an updated object state identifier on the second terminal device corresponding to the at least one second virtual object, the processor is specifically configured to change, according to a behavior execution progress of the target interaction object, the object state identifier corresponding to the target interaction object, and display an updated behavior execution progress at the object state identifier on the second terminal device corresponding to the at least one second virtual object.

In a feasible implementation solution, when executing the step of changing, according to the state parameter, the object state identifier corresponding to the target interaction object, and displaying an updated object state identifier on the second terminal device corresponding to the at least one second virtual object, the processor is specifically configured to cancel, if the state parameter indicates that the execution of the target interaction behavior corresponding to the target interaction object is completed, display of the object state identifier corresponding to the target interaction object, and cancel, on the second terminal device corresponding to the at least one second virtual object, the display of the object state identifier.

In a feasible implementation solution, the processor is further configured to display content of a target interaction behavior corresponding to each target interaction object in the task area; where the content of the target interaction behavior is associated with the object state identifier.

In a feasible implementation solution, the content of the target interaction behavior includes any one or a plurality of the following: deciphering a password, obtaining a virtual object, rescuing a virtual character, and/or operating a virtual switch.

In a feasible implementation solution, a display mode of the content of the target interaction behavior is a style of the target interaction object.

In a feasible implementation solution, the processor is further configured to update, in response to the execution of the target interaction behavior corresponding to the target interaction object being completed, the content of the target interaction behavior corresponding to the target interaction object in the task area to an interaction behavior execution result corresponding to the target interaction object.

In a feasible implementation solution, before the updating the content of the target interaction behavior corresponding to the target interaction object in the task area to an interaction behavior execution result corresponding to the target interaction object, the processor is further configured to, in response to that the execution of the target interaction behavior corresponding to the target interaction object is completed, display an association effect between the content of the target interaction behavior and the object state identifier according to a preset dynamic display effect.

By means of the above manner, a prompt for the specified location of the target interaction object is given to the player, and the state parameter of the target interaction object is determined according to the target interaction behavior which is executed by the virtual character with the target interaction object. Then the object state identifier corresponding to the target interaction object on each terminal device is changed according to the state parameter, and the prompt for the specified location of the target interaction object that has not yet executed the target interaction behavior can be more effectively given, so that the player can know the specified location of each target interaction object that really needs to execute the target interaction behavior, thereby avoiding the situation that when the virtual character arrives at the specified location, the target interaction behavior which needs to be executed by the virtual character with the target interaction object has been completed or the target interaction behavior is being executed, and consequently the player needs to change a task execution location again. This improves the game experience of the player and prompt efficiency for game tasks such as the interaction behavior, thereby alleviating the technical problem of low prompt efficiency for a game task at present, and also reducing the processing burden of the terminal device and saving the power of the terminal device.

In the embodiments of the present disclosure, when the computer program is run by the processor, other machine-readable instructions may be further executed, to perform other methods as in the embodiments. For the specific execution steps and principles of the method, refer to the description of the embodiments. Details will not be repeated herein.

In the embodiments provided by the present disclosure, it should be understood that the apparatus and method disclosed may be implemented in other ways. The apparatus embodiments described above are merely illustrative. For example, the division of the units is merely a logical function division, and there may be other division methods during actual implementation. For another example, a plurality of units or components may be combined or integrated into another system, or some features may be omitted or not performed. In addition, shown or discussed mutual coupling or direct coupling or communication connection may be implemented by means of some communication interfaces, and indirect coupling or communication connection between the apparatuses or units may be in an electrical form, a mechanical form, or other forms.

For another example, the flowcharts and the block diagrams in the drawings show the possible system architecture, functions, and operations of the apparatus, method, and computer program product according to multiple embodiments of the present disclosure. In this regard, each block in the flowcharts or the block diagrams may represent a module, a program segment, or a part of a code, which includes one or a plurality of executable instructions for implementing specified logical functions. It should also be noted that, in some embodiments, the functions marked in the blocks may occur in an order different from the order marked in the drawings. For example, two consecutive blocks may actually be executed substantially in parallel, or they may sometimes be executed in a reverse order, depending on the functions involved. It should also be noted that each block in the block diagrams and/or the flowcharts, and combinations of the blocks in the block diagrams and/or the flowcharts, may be implemented by a dedicated hardware-based system that performs the specified functions or actions, or may be implemented by combinations of dedicated hardware and computer instructions.

The units described as separate parts may or may not be physically separate, and parts displayed as units may or may not be physical units, and may be located in one location, or may be distributed on a plurality of network units. Some or all of the units may be selected according to actual needs to achieve the objectives of the solutions of the embodiments.

In addition, functional units in the embodiments provided by the present disclosure may be integrated into one processing unit, or each unit may exist alone physically, or two or more units may be integrated into one unit.

The functions, if implemented in the form of software functional units and sold or used as an independent product, may be stored in a computer-readable storage medium. Based on such understanding, the technical solution of the present disclosure essentially, or a part contributing to the related art, or a part of the technical solution may be embodied in the form of a software product, and the computer software product is stored in a storage medium, and includes several instructions to cause a computer device (which may be a personal computer, a server, or a network device, etc.) to perform all or some of the steps of the method for giving a prompt for a task in a game described in the embodiments of the present disclosure. The aforementioned storage medium includes: any type of medium capable of storing a program code, such as a USB flash drive, a removable hard disk drive, a read-only memory (ROM), a random access memory (RAM), a magnetic disk, or an optical disk.

It should be noted that: similar reference numerals and letters represent similar items in the following drawings, therefore, once an item is defined in one drawing, it does not need to be further defined and explained in the subsequent drawings, and in addition, the terms “first”, “second”, “third”, etc. are only used for distinguishing descriptions, and cannot be understood as indicating or implying relative importance.

Finally, it should be noted that: the above embodiments are only specific implementations of the present disclosure, and are used to illustrate the technical solutions of the present disclosure, rather than to limit the same, and the scope of protection of the present disclosure is not limited thereto. Although the present disclosure is described in detail with reference to the foregoing embodiments, persons of ordinary skill in the art should understand:
any person skilled in the technical field can still make modifications or easily conceive of changes to the technical solutions described in the foregoing embodiments within the technical scope disclosed in the present disclosure, or make equivalent replacements to some of the technical features. These modifications, changes or replacements do not make the essence of the corresponding technical solutions depart from the scope of the technical solutions of the embodiments of the present disclosure, and all should be covered within the protection scope of the present disclosure. Therefore, the protection scope of the present disclosure should be subject to the protection scope of the claims.

1. A method for providing a prompt for a task in a game, comprising:
displaying, on a graphical user interface of a first terminal device, the a game scene, a scene map corresponding to the game scene, and a task area, wherein the game scene comprises a first virtual character controlled by the first terminal device and at least one second virtual object controlled by a second terminal device, and a target interaction object is set at each of at least two specified locations in the game scene;
displaying, in the scene map, an object location identifier corresponding to the target interaction object at a map location corresponding to the specified location;
displaying, in the task area, an object state identifier corresponding to the target interaction object, wherein the object location identifier is in one-to-one correspondence with a respective object state identifier;
controlling, in response to a control instruction for the first virtual character, the first virtual character to execute a target interaction behavior with the target interaction object located at the specified location;
determining a state parameter of the target interaction object based on the target interaction behavior; and
changing, based on the state parameter, the object state identifier corresponding to the target interaction object, and displaying an updated object state identifier on the second terminal device corresponding to the at least one second virtual object.

2. The method according to claim 1, wherein the state parameter comprises at least one of:
an execution of the target interaction behavior not having started,
an execution of the target interaction behavior being in progress,
an execution of the target interaction behavior being completed,
an execution progress of the target interaction behavior,
an execution stage of the target interaction behavior,
an execution of the target interaction behavior being interrupted, or
an execution of the target interaction behavior stopping.

3. The method according to claim 1, wherein changing the object state identifier comprises at least one of:
changing a color of the object state identifier,
changing a brightness of the object state identifier,
changing a transparency of the object state identifier,
changing a shape of the object state identifier, or
changing an effect of the object state identifier dynamically.

4. The method according to claim 1, wherein changing, based on the state parameter, the object state identifier corresponding to the target interaction object, and displaying an updated object state identifier on the second terminal device corresponding to the at least one second virtual object comprises:
changing, based on a behavior execution progress of the target interaction object, the object state identifier corresponding to the target interaction object, and
displaying, on the second terminal device corresponding to the at least one second virtual object, an updated behavior execution progress at the object state identifier.

5. The method according to claim 1, wherein the changing, based on the state parameter, the object state identifier corresponding to the target interaction object, and displaying an updated object state identifier on the second terminal device corresponding to the at least one second virtual object comprises:
in response to determining that the state parameter indicating that the an execution of the target interaction behavior corresponding to the target interaction object is completed:
canceling display of the object state identifier corresponding to the target interaction object, and
canceling, on the second terminal device corresponding to the at least one second virtual object, the display of the object state identifier.

6. The method according to claim 1, further comprising:
displaying content of a target interaction behavior corresponding to each target interaction object in the task area, wherein the content of the target interaction behavior is associated with the object state identifier.

7. The method according to claim 6, wherein the content of the target interaction behavior comprises at least one of:
deciphering a password,
obtaining a virtual object,
rescuing a virtual character, and/or or
operating a virtual switch.

8. The method according to claim 6, wherein a display mode of the content of the target interaction behavior is comprises a style of the target interaction object.

9. The method according to claim 6, further comprising:
updating, in response to an execution of the target interaction behavior corresponding to the target interaction object being completed, the content of the target interaction behavior in the task area to an interaction behavior execution result corresponding to the target interaction object.

10. The method according to claim 9, before the updating the content of the target interaction behavior corresponding in the task area to the interaction behavior execution result corresponding to the target interaction object, further comprising:
in response to that the execution of the target interaction behavior corresponding to the target interaction object being completed, displaying an association effect between the content of the target interaction behavior and the object state identifier based on a preset dynamic display effect.

11. (canceled)

12. A system, comprising:
one or more memories collectively containing one or more programs; and
one or more processors, wherein the one or more processors are configured to, individually or collectively, perform an operation comprising:
displaying, on a graphical user interface of a first terminal device, a game scene, a scene map corresponding to the game scene, and a task area, wherein the game scene comprises a first virtual character controlled by the first terminal device and at least one second virtual object controlled by a second terminal device, and a target interaction object is set at each of at least two specified locations in the game scene;
displaying, in the scene map, an object location identifier corresponding to the target interaction object at a map location corresponding to the specified location;
displaying, in the task area, an object state identifier corresponding to the target interaction object, wherein the object location identifier is in one-to-one correspondence with a respective object state identifier;
controlling, in response to a control instruction for the first virtual character, the first virtual character to execute a target interaction behavior with the target interaction object located at the specified location;
determining a state parameter of the target interaction object based on the target interaction behavior; and
changing, based on the state parameter, the object state identifier corresponding to the target interaction object, and displaying an updated object state identifier on the second terminal device corresponding to the at least one second virtual object.

13. One or more non-transitory computer-readable storage media containing, in any combination, computer program code that, when executable by a computer system, perform an operation comprising:
displaying, on a graphical user interface of a first terminal device, a game scene, a scene map corresponding to the game scene, and a task area, wherein the game scene comprises a first virtual character controlled by the first terminal device and at least one second virtual object controlled by a second terminal device, and a target interaction object is set at each of at least two specified locations in the game scene;
displaying, in the scene map, an object location identifier corresponding to the target interaction object at a map location corresponding to the specified location;
displaying, in the task area, an object state identifier corresponding to the target interaction object, wherein the object location identifier is in one-to-one correspondence with a respective object state identifier;
controlling, in response to a control instruction for the first virtual character, the first virtual character to execute a target interaction behavior with the target interaction object located at the specified location;
determining a state parameter of the target interaction object based on the target interaction behavior; and
changing, based on the state parameter, the object state identifier corresponding to the target interaction object, and displaying an updated object state identifier on the second terminal device corresponding to the at least one second virtual object.

14. The system according to claim 12, wherein the state parameter comprises at least one of:
an execution of the target interaction behavior not having started,
an execution of the target interaction behavior being in progress,
an execution of the target interaction behavior being completed,
an execution progress of the target interaction behavior,
an execution stage of the target interaction behavior,
an execution of the target interaction behavior being interrupted, or
an execution of the target interaction behavior stopping.

15. The system according to claim 12, wherein changing the object state identifier comprises at least one of:
changing a color of the object state identifier,
changing a brightness of the object state identifier,
changing a transparency of the object state identifier,
changing a shape of the object state identifier, or
changing an effect of the object state identifier dynamically.

16. The system according to claim 12, wherein changing, based on the state parameter, the object state identifier corresponding to the target interaction object, and displaying an updated object state identifier on the second terminal device corresponding to the at least one second virtual object comprises:
changing, based on a behavior execution progress of the target interaction object, the object state identifier corresponding to the target interaction object, and
displaying, on the second terminal device corresponding to the at least one second virtual object, an updated behavior execution progress at the object state identifier.

17. The system according to claim 12, wherein changing, based on the state parameter, the object state identifier corresponding to the target interaction object, and displaying an updated object state identifier on the second terminal device corresponding to the at least one second virtual object comprises:
in response to determining that the state parameter indicating that an execution of the target interaction behavior corresponding to the target interaction object is completed:
canceling display of the object state identifier corresponding to the target interaction object, and
canceling, on the second terminal device corresponding to the at least one second virtual object, the display of the object state identifier.

18. The system according to claim 12, wherein the operation further comprises:
displaying content of a target interaction behavior corresponding to each target interaction object in the task area, wherein the content of the target interaction behavior is associated with the object state identifier.

19. The system according to claim 18, wherein the content of the target interaction behavior comprises at least one of:
deciphering a password,
obtaining a virtual object,
rescuing a virtual character, or
operating a virtual switch.

20. The system according to claim 18, wherein the operation further comprises:
updating, in response to the execution of the target interaction behavior corresponding to the target interaction object being completed, the content of the target interaction behavior in the task area to an interaction behavior execution result corresponding to the target interaction object.

21. The system according to claim 20, wherein, before updating the content of the target interaction behavior in the task area to the interaction behavior execution result corresponding to the target interaction object, the operation further comprises:
in response to the execution of the target interaction behavior corresponding to the target interaction object being completed, displaying an association effect between the content of the target interaction behavior and the object state identifier based on a preset dynamic display effect.
